(19) United States
(12) Patent Application Publication
(10) Pub. No.: US 2025/0211437 A1
(43) Pub. Date: Jun. 26, 2025

(54) MAGNETIC DISK DEVICE

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Taku NISHIMURA, Yokohama (JP)

(73) Assignees: KABUSHIKI KAISHA TOSHIBA, Tokyo (JP); TOSHIBA ELECTRONIC DEVICES & STORAGE CORPORATION, Tokyo (JP)

(21) Appl. No.: 18/630,140

(22) Filed: Apr. 9, 2024

(30) Foreign Application Priority Data
Dec. 21, 2023 (JP) 2023-215598

(51) Int. Cl. H04L 9/08

(52) U.S. Cl. CPC H04L 9/088

(57) ABSTRACT

According to one embodiment, a magnetic disk device includes a nonvolatile memory including a firmware area in which firmware is stored and an encryption key area in which a first encryption key is stored, and a controller enabling the firmware to be updated when reading the first encryption key from the encryption key area and programing information including a second encryption key into the encryption key area.

### CROSS-REFERENCE TO RELATED APPLICATIONS

This application is based upon and claims the benefit of priority from Japanese Patent Application No. 2023-215598, filed Dec. 21, 2023, the entire contents of which are incorporated herein by reference.

### FIELD

Embodiments described herein relate generally to a magnetic disk device.

### BACKGROUND

In magnetic disk devices, firmware update (rewriting) is performed by protocol communication between the System-on-a-Chip (SoC), which constitutes a main controller, and a nonvolatile memory which stores the firmware. Conventionally, magnetic disk devices do not comprise a protection function for firmware update (rewriting). For this reason, the firmware may be unintentionally updated from the outside.

In addition, conventionally, the magnetic disk devices do not comprise a function of detecting and repairing firmware corruption at arbitrary intervals if firmware is corrupted. If the firmware is not in a normal state due to corruption or unintentional updates, the magnetic disk devices may not boot. When a magnetic disk device is in a state of not booting, analyzing its state is also difficult.

### BRIEF DESCRIPTION OF THE DRAWINGS

FIG. 1 is a block diagram showing a configuration of a magnetic disk device according to an embodiment.

FIG. 2 is a flowchart showing a procedure for updating the firmware.

FIG. 3 is a block diagram illustrating updating the firmware.

FIG. 4 is a flowchart showing an example of a procedure for detecting and repairing a firmware status.

FIG. 5 is a flowchart showing an example of the procedure for detecting and repairing the firmware status, following FIG. 4.

FIG. 6 is a flowchart showing an example of the procedure for detecting and repairing the firmware status, following FIG. 4.

FIG. 7 is a block diagram for explaining the repair of firmware when one of the first or second firmware is normal and the other is not.

### DETAILED DESCRIPTION

In general, according to one embodiment, there is provided a magnetic disk device including a nonvolatile memory including a firmware area in which firmware is stored and an encryption key area in which a first encryption key is stored, and a controller enabling the firmware to be updated when reading the first encryption key from the encryption key area and programing information including a second encryption key into the encryption key area.

In addition, according to another embodiment, there is provided a magnetic disk device including a host operated by a user, a nonvolatile memory including a firmware area in which first firmware and second firmware are stored, and a controller determining whether or not the first firmware and the second firmware are normal for each arbitrary period and, if determining that at least one of the first firmware and the second firmware are not normal, notifying the user of the information on whether or not the first firmware and the second firmware are normal, via the host.

Embodiments will be described hereinafter with reference to the accompanying drawings. The disclosure is merely an example, and proper changes within the spirit of the invention, which are easily conceivable by a person of ordinary skill in the art, are included in the scope of the invention as a matter of course. In addition, in some cases, in order to make the description clearer, the widths, thicknesses, shapes and the like, of the respective parts are schematically illustrated in the drawings, compared to the actual modes. However, the schematic illustration is merely an example, and adds no restriction to the interpretation of the invention. Besides, in the specification and drawings, the same elements as those described in connection with preceding drawings are denoted by like reference numbers, and a detailed description thereof is omitted unless necessary.

A magnetic disk device according to an embodiment will be described hereinafter with reference to the accompanying drawings.

First, a configuration of a magnetic disk device 1 will be described.

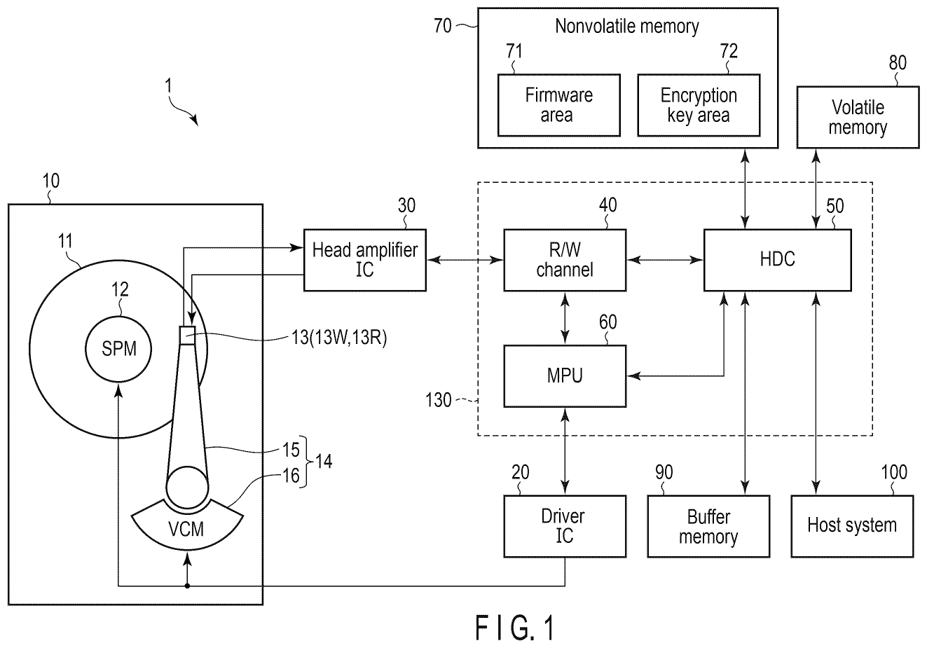

FIG. 1 is a block diagram showing a configuration of the magnetic disk device 1.

As shown in FIG. 1, the magnetic disk device 1 comprises a rectangular housing 10, a magnetic disk 11 serving as a storage medium arranged in the housing 10, a spindle motor (SPM) 12 which supports and rotates the magnetic disk 11, and magnetic heads 13 including a write head 13W which writes data to the magnetic disk 11 and a read head 13R which reads data from the magnetic disk 11.

The magnetic disk device 1 comprises a head actuator 14 which moves and positions the magnetic heads 13 above arbitrary tracks on the magnetic disk 11. The head actuator 14 includes a carriage assembly 15 which supports the magnetic heads 13 such that the magnetic heads 13 are movable, and a voice coil motor (VCM) 16 which rotates the carriage assembly 15.

The magnetic disk device 1 comprises a head amplifier IC (preamplifier) 30 which drives the magnetic heads 13, a main controller 130, a driver IC 20, a nonvolatile memory 70, a volatile memory 80, and a buffer memory 90. The head amplifier IC 30 is electrically connected to the magnetic heads 13.

The head amplifier IC 30 comprises a read amplifier and a write driver. The read amplifier amplifies a read signal which is read from the magnetic disk 11 by the read head 13R, and outputs the amplified read signal to a main controller 130 (more specifically, a read/write (R/W) channel 40 to be described later). The write driver outputs a write current corresponding to the signal output from the R/W channel 40, to the write head 13W.

The main controller 130 and the driver IC 20 are constituted on, for example, a control circuit board (not shown) provided on a back surface side of the housing 10. The main controller (controller) 130 is realized by, for example, using a large-scale integrated circuit (LSI) referred to as a system-on-a-chip (SoC) in which a plurality of elements are integrated on a single chip. The main controller 130 includes an R/W channel 40, a hard disk controller (HDC) 50, and a microprocessor (MPU) 60. The main controller 130 is electrically connected to the VCM 16 and the SPM 12 via the driver IC 20. The HDC 50 can be connected to a host system (host) 100.

The R/W channel 40 is a read/write data signal processing circuit. The HDC 50 controls data transfer between the host 100 and the R/W channel 40 in accordance with instructions from the MPU 60. The HDC 50 is electrically connected to the R/W channel 40, the MPU 60, the nonvolatile memory 70, the volatile memory 80, and the buffer memory 90. Incidentally, the main controller 130 (HDC 50) and the nonvolatile memory 70 may be connected via a wireless line.

The nonvolatile memory 70 is a semiconductor memory which records data stored even when power supply is cut off. In one example, the nonvolatile memory 70 is a flash read only memory (flash ROM: FROM). The nonvolatile memory 70 has a firmware area 71 in which firmware is stored and an encryption key area 72 in which an encryption key is stored. In one example, two types of firmware are stored in the firmware area 71. The nonvolatile memory 70 has a protect bit for protecting a specific area and making it unchangeable. When a protect bit is set to 0, the specific area is unchangeable, and when a protect bit is set to 1, it becomes rewritable.

The encryption key area 72 is assigned an address different from the address of the firmware area 71, in the nonvolatile memory 70. In addition, an initial value of an encryption key obtained when the magnetic disk device 1 is manufactured is a unique value, for example, a serial number of the control circuit board.

The volatile memory 80 is a semiconductor memory where the stored data is lost when power supply is cut off. The volatile memory 80 stores data and the like necessary for processing in each unit of the magnetic disk device 1. The volatile memory 80 is, for example, a dynamic random access memory (DRAM) or a synchronous dynamic random access memory (SDRAM).

The buffer memory 90 is a semiconductor memory which temporarily records data and the like transmitted and received between the magnetic disk device 1 and the host 100. Incidentally, the buffer memory 90 may be constituted integrally with the volatile memory 80. The buffer memory 90 is, for example, a DRAM, a static random access memory (SRAM), an SDRAM, a ferroelectric random access memory (FeRAM), a magnetoresistive random access memory (MRAM) or the like.

The MPU 60 is a main control unit of the magnetic disk device 1 and executes control of the read/write operations and servo control necessary for positioning of the magnetic head 13. When performing a write operation, the MPU 60 controls the VCM 16 via the driver IC 20 in accordance with commands from the host 100 and the like to arrange the magnetic head 13 at a predetermined position on the magnetic disk 11 and write the data. When performing a read operation, the MPU 60 controls the VCM 16 via the driver IC 20 in accordance with commands from the host 100 and the like to arrange the magnetic head 13 at a predetermined position on the magnetic disk 11 and read the data.

The processing that the main controller 130 can perform will be described here.

When receiving a firmware update command (FW update command) to update the firmware in the firmware area 71 from the host 100, the main controller 130 can update the firmware by performing a predetermined protocol (procedure) using an encryption key.

The main controller 130 can read the encryption key from the encryption key area and program the information including the encryption key in the encryption key area. In the following descriptions, “to program” can be restated as “to store”, “to write”, or “to overwrite”.

The main controller 130 can change the encryption key (referred to as “first encryption key”) read from the encryption key area to a second encryption key different from the first encryption key.

The main controller 130 can generate encryption key information in which the update time and update count of receiving the FW update commands from the host 100 are associated with the encryption key.

The main controller 130 can copy one of the two firmware to the other.

The main controller 130 can determine whether or not the firmware in the firmware area 71 is normal for each arbitrary period. The above-described arbitrary period is, for example, the period from the timing when the magnetic disk device 1 is started to the timing when the magnetic disk device 1 is next started. In addition, the above-described arbitrary period can be changed as needed by a command from the user via the host 100.

When the firmware is not normal, the main controller 130 can notify the user of the information regarding whether or not the firmware is normal, via the host 100. Furthermore, the main controller 130 can repair the firmware by copying the firmware which is determined to be normal to the firmware which is determined not to be normal.

The magnetic disk device 1 is configured as described above.

Next, the process for updating the firmware will be described.

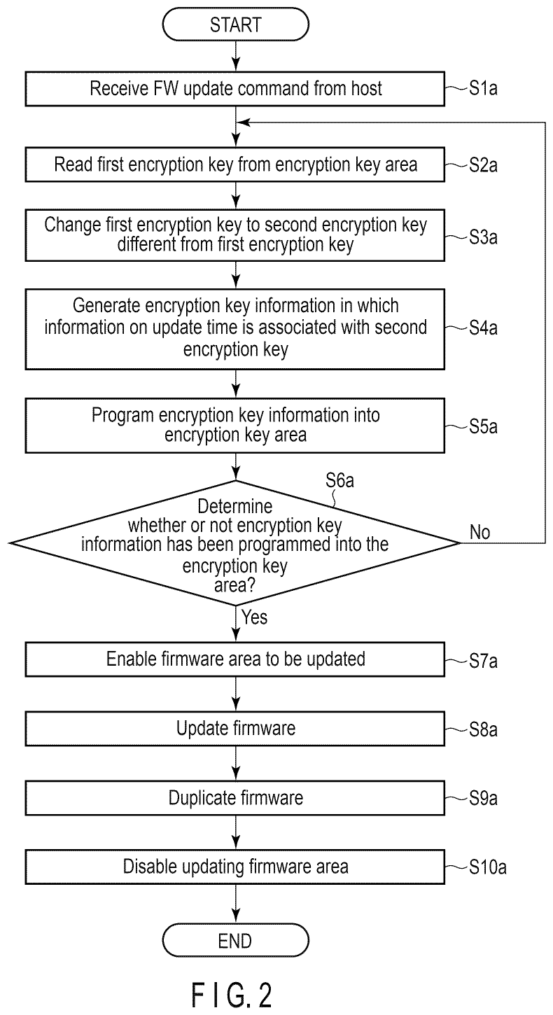

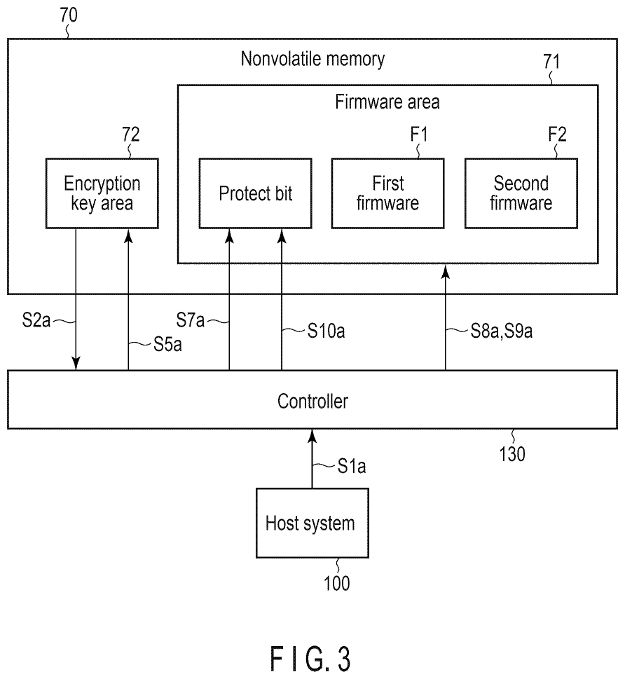

FIG. 2 is a flowchart showing a procedure for updating the firmware. FIG. 3 is a block diagram illustrating updating the firmware.

As shown in FIG. 2 and FIG. 3, when the main controller 130 receives the FW update command from the host 100 (Sla) and a process for updating the firmware is started, the main controller 130 reads the encryption key (referred to as “first encryption key”) from the encryption key area 72 (S2a).

Next, the main controller 130 changes the first encryption key to a second encryption key that is different from the first encryption key (S3a). More specifically, the main controller 130 changes the first encryption key to the second encryption key by adding a randomly generated random value α to the first encryption key. The random value α is, for example, a pseudo-random number or a random variable.

Then, the main controller 130 generates encryption key information in which information on the update time and update count is associated with the second encryption key (S4a). More specifically, the main controller 130 adds a time stamp of the update time and update count to the end of the second encryption key.

After that, the main controller 130 programs the encryption key information into the encryption key area 72 (S5a). In one example, when the encryption key information is programmed into the encryption key area 72, the firmware in the nonvolatile memory 70 outputs a notification signal notifying that the encryption key information has been programmed, to the main controller 130.

Next, the main controller 130 determines whether or not the encryption key information has been programmed into the encryption key area 72 (S6a). In one example, the main controller 130 determines whether or not the encryption key information has been programmed into the encryption key area 72 according to whether or not the main controller 130 has received a notification signal.

If determining that no encryption key information has been programmed into the encryption key area 72 (S6a), the main controller 130 shifts to step S2a. Incidentally, if determining in the manner as described above, the main controller 130 may end the process to update the firmware, although not shown in FIG. 2.

If determining that the encryption key information has been programmed into the encryption key area 72 (S6a), the main controller 130 enables the firmware update (S7a). More specifically, the main controller 130 unprotects the firmware area 71 by setting a protect bit in the firmware area 71 to 0.

Then, the main controller 130 updates the firmware according to the FW update command from the host 100 (S8a). An example of the procedure of step S8a will be described below.

The main controller 130 obtains information on one of the two firmware (for example, first firmware F1). After that, if the firmware is encrypted, the main controller 130 then decrypts the firmware, updates the firmware according to the FW update command, and encrypts the updated firmware. Then, the main controller 130 transmits the updated firmware to the firmware area 71.

After that, the main controller 130 duplicates the updated firmware (S9a). More specifically, the main controller 130 copies one updated firmware (for example, first firmware F1) to the other firmware (for example, second firmware F2).

Next, the main controller 130 disables the firmware update (S10a) and ends the process for updating the firmware. In step S10a, more specifically, the main controller 130 protects the firmware area 71 by setting the protect bit in the firmware area 71 to 1.

Incidentally, steps S3a and S4a may not be performed in the embodiment. In this case, the main controller 130 reads the first encryption key from the encryption key area 72 (S2a) and then programs the encryption key information including the second encryption key identical to the first encryption key into the encryption key area 72 (S5a).

In addition, step S3a may not be performed in the embodiment. In this case, the main controller 130 reads the first encryption key from the encryption key area 72 (S2a), and then generates the encryption key information in which the update time information is associated with the second encryption key identical to the first encryption key (S4a).

Furthermore, step S4a may not be performed in the embodiment. In this case, the main controller 130 changes the first encryption key to a second encryption key different from the first encryption key (S3a), and then programs the encryption key information including the second encryption key different from the first encryption key in the encryption key area 72 (S5a).

Next, a process of detecting and repairing the firmware status will be described.

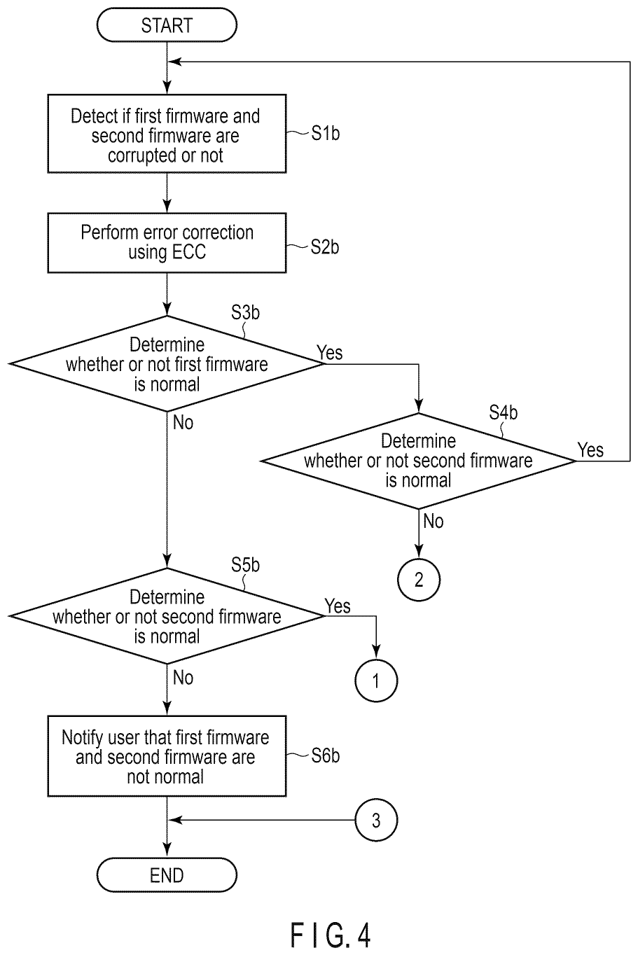

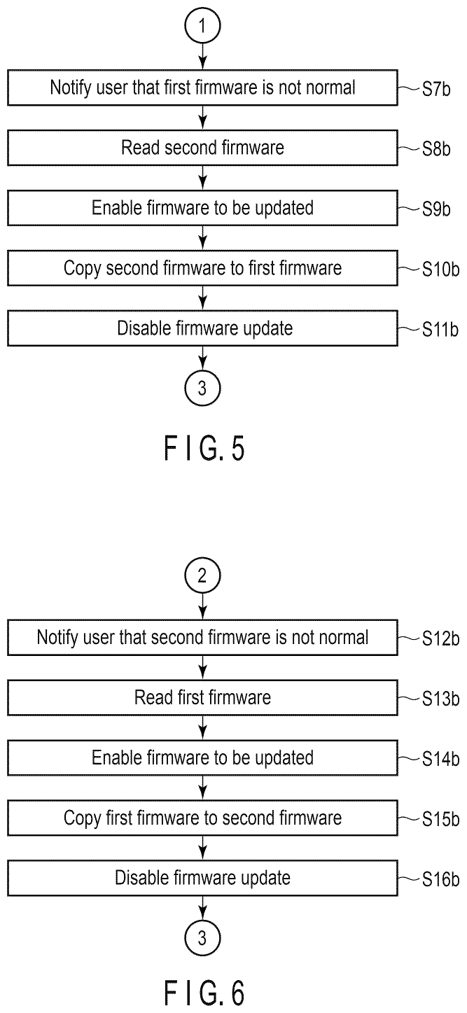

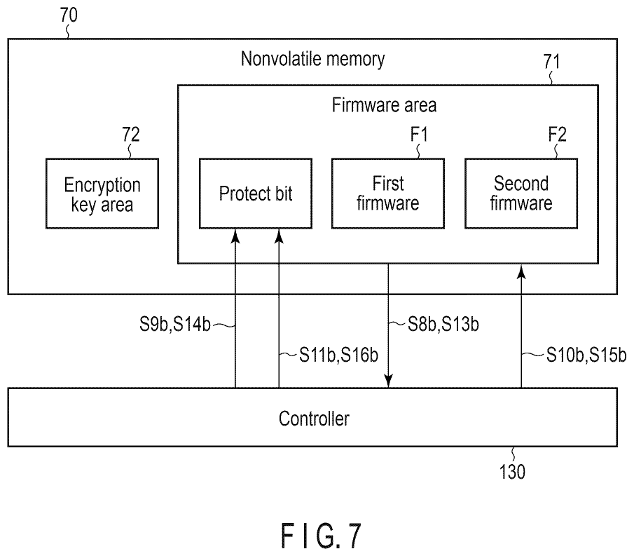

FIG. 4 is a flowchart showing an example of a procedure for detecting and repairing a firmware status. FIG. 5 is a flowchart showing an example of the procedure for detecting and repairing the firmware status, following FIG. 4. FIG. 6 is a flowchart showing an example of the procedure for detecting and repairing the firmware status, following FIG. 4. FIG. 7 is a block diagram for explaining the repair of firmware when one of the first or second firmware is normal and the other is not.

As shown in FIG. 4 through FIG. 7, when the process of detecting and repairing the firmware status is started, the main controller 130 first detects corruption of the first firmware F1 and the second firmware F2 (S1b), and performs error correction using error correction code (ECC) for codes of the first firmware F1 and the second firmware (S2b). ECC is a method used to correct data errors. Incidentally, the error correction using ECC may be performed in the program by the firmware in the firmware area 71, in step S2b.

Next, the main controller 130 determines whether or not the first firmware F1 is normal (S3b) and then determines whether or not the second firmware F2 is normal (S4b and S5b). In one example, the main controller 130 determines that the firmware is normal if no corruption is detected in step S1b or if error correction can be performed in step S2b. In addition, the main controller 130 determines that the firmware is not normal if the corruption is detected in step S1b and the error correction cannot be performed in step S2b.

If determining that both the first firmware F1 and the second firmware F2 are normal (S3b and S4b), the main controller 130 shifts to step S1b.

If determining that both the first firmware F1 and the second firmware F2 are not normal (S3b and S5b), the main controller 130 notifies the user that the first firmware F1 and the second firmware F2 are not normal, via the host 100 (S6b), and ends the process of detecting and repairing the firmware status.

In step S6b, more specifically, the main controller 130 raises an alarm indicating that both the first firmware F1 and the second firmware F2 are uncorrectable.

If determining that the first firmware F1 is not normal (S3b) and that the second firmware F2 is normal (S5b), the main controller 130 notifies the user that the first firmware F1 is not normal, via the host 100 (S7b). More specifically, the main controller 130 raises an alarm indicating that the first firmware F1 is corrupted and that the second firmware F2 is normal.

Next, the main controller 130 reads the second firmware F2 that is determined to be normal (S8b) and sets the protect bit to 0 to enable the firmware to be updated (S9b).

Then, the main controller 130 copies the second firmware F2 to the first firmware F1 (S10b), sets the protect bit to 1 to disable the firmware update (S11b), and ends the process of detecting and repairing the firmware status.

If determining that the first firmware F1 is normal (S3b) and that the second firmware F2 is not normal (S4b), the main controller 130 notifies the user that the second firmware F2 is not normal, via the host 100 (S12b). More specifically, the main controller 130 raises an alarm indicating that the second firmware F2 is corrupted and that the first firmware F1 is normal.

Next, the main controller 130 reads the first firmware F1 that is determined to be normal (S13b) and sets the protect bit to 0 to enable the firmware to be updated (S14b).

Then, the main controller 130 copies the first firmware F1 to the second firmware F2 (S15b), sets the protect bit to 1 to disable the firmware updates (S16b), and ends the process of detecting and repairing the firmware status.

Advantages of the present embodiment will be described.

According to the magnetic disk device 1 of the present embodiment, the main controller 130 enables the firmware update when reading the first encryption key and programming the information including the second encryption key. The firmware is thereby protected from unintentional updates.

Furthermore, the initial value of the encryption key is the serial number of the control circuit board. As a result, the initial value of the encryption key can be set to a unique value different from the values of the other magnetic disk devices.

The main controller 130 changes the first encryption key to the second encryption key that is different from the first encryption key. The protection performance of the firmware can be thereby improved.

The main controller 130 generates the encryption key information in which the information on the update time is associated with the second encryption key. As a result, it can be determined whether or not the firmware update has been intentionally performed.

The security level of the firmware can be improved and the firmware becoming in an unnormal status due to unintentional updates can be suppressed, by the above-described configuration using the encryption key.

If determining whether or not the first firmware F1 and the second firmware F2 are normal and determining that at least one of the first firmware F1 and the second firmware F2 are not normal, the main controller 130 notifies the user of the information on whether or not the first firmware F1 and the second firmware F2 are normal. The user can thereby recognize the abnormality of the firmware.

The main controller 130 determines whether or not the firmware is normal, based on the error correction using the ECC and the detection of corruption. Furthermore, the error correction using the ECC and the detection of corruption can be performed at any interval. As a result, it can be determined whether or not the firmware is normal at an interval desired by the user.

If determining that one of the two firmware is normal and the other is not, the main controller 130 copies the firmware that is determined normal to the firmware that is determined unnormal. As a result, even if one firmware is corrupted, the firmware can be automatically repaired.

In summary, the highly reliable magnetic disk device 1 with the firmware maintained in a normal state can be obtained by the above-described configuration.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A magnetic disk device comprising:
a nonvolatile memory including a firmware area in which firmware is stored and an encryption key area in which a first encryption key is stored; and
a controller enabling the firmware to be updated when reading the first encryption key from the encryption key area and programing information including a second encryption key into the encryption key area.

2. The magnetic disk device of claim 1, wherein
the controller is constituted on a control circuit board, and
the first encryption key is a serial number of the control circuit board.

3. The magnetic disk device of claim 1, wherein
the controller changes the first encryption key to the second encryption key different from the first encryption key.

4. The magnetic disk device of claim 1, wherein
the controller generates encryption key information in which information on an update time of the firmware is associated with the second encryption key.

5. A magnetic disk device comprising:
a host operated by a user;
a nonvolatile memory including a firmware area in which first firmware and second firmware are stored; and
a controller determining whether or not the first firmware and the second firmware are normal for each arbitrary period and, if determining that at least one of the first firmware and the second firmware are not normal, notifying the user of the information on whether or not the first firmware and the second firmware are normal, via the host.

6. The magnetic disk device of claim 5, wherein
the controller
performs error correction using ECC and detection of corruption for the first firmware and the second firmware, for each arbitrary period,
determines that the first firmware is normal if the error correction is operable for the first firmware or no corruption is detected in the first firmware, and
determines that the second firmware is normal if the error correction is operable for the second firmware or no corruption is detected in the second firmware.

7. The magnetic disk device of claim 5, wherein
the controller
performs error correction using ECC and detection of corruption for the first firmware and the second firmware, for each arbitrary period,
determines that the first firmware is not normal if the error correction is inoperable for the first firmware and a corruption is detected in the first firmware, and
determines that the second firmware is not normal if the error correction is inoperable for the second firmware and a corruption is detected in the second firmware.

8. The magnetic disk device of claim 5, wherein
if determining that the first firmware is normal and that the second firmware is not normal, the controller copies the first firmware to the second firmware.
